(19) United States
(12) Patent Application Publication
(10) Pub. No.: US 2007/0033256 A1
(43) Pub. Date: Feb. 8, 2007

(54) SYSTEM AND METHOD FOR THE PREVENTION OF UNSOLICITED CALLS AND CONTACTS

(76) Inventor: Yuval Ben-Itzhak, Tel Aviv (IL)

Correspondence Address: PERKINS COIE LLP, P.O. BOX 2168, MENLO PARK, CA, 94026, US

(21) Appl. No.: 11/457,126

(22) Filed: Jul. 12, 2006

Related U.S. Application Data
(60) Provisional application No. 60/698,086, filed on Jul. 12, 2005.

(51) Int. Cl. G06F 15/16

(52) U.S. Cl. 709/206

(57) ABSTRACT

Embodiments of a system for preventing unwanted calls are presented. In one embodiment, the system includes a transmitter, for transmitting an electronic message to a user, a receiver communicatively coupled with the transmitter, for receiving the electronic message intended for the user, and a message filter coupled with the receiver, including a message interceptor, for intercepting the electronic message, transmitted by the transmitter, prior to the electronic message being received by the receiver, a verification processor, for determining if the electronic message is unwanted, including a challenge originator, for issuing a challenge in the form of a query to the transmitter, and a validator, for receiving a response to the challenge from the transmitter and for determining the validity of the response, and a message manager, for passing the electronic message to the receiver, if the verification processor determines that the electronic message is not unwanted. Embodiments of a method and a computer-readable storage medium are also described and claimed.

### PRIORITY REFERENCE TO RELATED APPLICATIONS

This application claims benefit of and hereby incorporates by reference U.S. Provisional Application No. 60/698,086, entitled “SYSTEM AND METHOD FOR THE PREVENTION OF UNSOLICITED CALLS AND CONTACTS”, filed on Jul. 12, 2005 by inventor Yuval Ben-ltzhak.

### BACKGROUND OF THE INVENTION

Connectivity, functionality and security are conflicting objectives in daily life. The modern world allows users to connect to each other in many ways, either for social or business reasons. New connectivity methods are introduced every few years thanks to new technology inventions such as voice & video over IP, instant messaging, peer-2-peer, mobile devices, SMS and e-mail. Unfortunately, the wealth of connectivity options between people is also being used for reasons they were not originally intended for; namely, for unsolicited calls and contacts.

Recently the number of unsolicited calls and contacts has reached a level where people are asking for both legal and security solutions to prevent them. The growing number of unsolicited calls and contacts suppresses people's willingness to communicate using new technologies, and abuses computers, networks and human resources.

Currently there are both legal and security solutions to prevent unsolicited calls and contacts, using limited methodology. Such solutions include the US government do-not-call registry, to prevent telephone solicitation by telemarketers, and anti-spam solutions for e-mail solicitation. Although there are debates regarding the effectiveness of these solutions, it is important to note that none of them relate to automatic prevention of unsolicited calls and contacts that are made using voice over IP, peer-2-peer and instant messaging communication technologies. Furthermore, these prior art methods do not guarantee reliability in preventing unsolicited calls.

It may thus be useful to provide a system and method for automatic prevention of unsolicited calls and contacts in voice/video over IP, mobile devices, SMS, peer-2-peer and instant messaging communication technologies, in a simple and efficient manner. Similarly, it may be advantageous to provide a system and method that prevents computer-based programs from contacting people in order to establish a call and/or contact for sending/playing automated messages (e.g., a marketing message).

### SUMMARY

The present invention, in some embodiments, relates to a method and system that prevents computer-based programs and humans from contacting people in order to establish a call and/or contact by saying/sending/playing a message (e.g. a marketing message). In one embodiment, a method includes (a) detecting the event of a 2^{nd} party initiating a contact/call with a user; (b) replying to the 2^{nd} party with a voice and/or video and/or text message challenging the 2^{nd} party to respond; (c) validating the correctness of the 2^{nd} party's reply for correctness; and (d) reporting detected events and replies.

Such validating may be performed by using predefined sets of logical rules, for deciding whether or not a reply is correct.

In one embodiment, some or all of the steps involved are carried out in a semi-automatic manner, requiring the user's approval.

In an embodiment, the reply to the 2^{nd} party may include a warning to alert the 2^{nd} party to avoid making unsolicited calls/contacts.

In another embodiment, before sending a reply to the 2^{nd} party the method checks if the 2^{nd} party is already registered in an “allow contact/call list”, based on 2^{nd} party attribute/s. If the 2^{nd} party is already in the list, the contact/call is allowed without the challenging message. In an embodiment, a 2^{nd} party whose contact/call is successfully validated is added to the allow contact/call list, with his attributes, so that future attempts by the same party are approved without challenging the party again. In an embodiment, the user is able to add/remove/edit information from the allow contact/call list in a manual and/or semi-automatic method. In another embodiment, the allow contact/call list is loaded with contact/call attributes that the user used in the past.

In yet another embodiment, the reply to the 2^{nd} party is based on randomly generated text and/or voice and/or video commands challenging the 2^{nd} party. In such an embodiment, the reply to the 2^{nd} party is based on a pre-defined list of text and/or voice and/or video commands challenging the 2^{nd} party. Also, in an embodiment, the reply to the 2^{nd} party is based on a mix from a pre-defined list and from randomly generated text and/or voice and/or video commands challenging the 2^{nd} party.

In another embodiment, the 2^{nd} party is allowed more than one attempt to reply with the correct information to the challenge.

In yet another embodiment, one or more modules of the system are separate from the user's device receiving the call/contact.

There is thus provided in some embodiments a system for preventing unwanted calls, including a transmitter, for transmitting an electronic message to a user, a receiver communicatively coupled with the transmitter, for receiving the electronic message intended for the user, and a message filter coupled with the receiver, including a message interceptor, for intercepting the electronic message, transmitted by the transmitter, prior to the electronic message being received by the receiver, a verification processor, for determining if the electronic message is unwanted, including a challenge originator, for issuing a challenge in the form of a query to the transmitter, and a validator, for receiving a response to the challenge from the transmitter and for determining the validity of the response, and a message manager, for passing the electronic message to the receiver, if the verification processor determines that the electronic message is not unwanted.

There is further provided in some embodiments a method for preventing unwanted calls, including intercepting an electronic message intended for delivery to a user, prior to the electronic message being received by the user, determining if the electronic message is unwanted, including issuing a challenge in the form of a query to an initiator of the electronic message, receiving a response to the challenge from the initiator, and validating the response to determine its validity, and passing the electronic message to the user, if the determining determines that the electronic message is not unwanted.

There is provided in other embodiments a computer-readable storage medium storing program code for causing at least one computing device to intercept an electronic message intended for delivery to a user, prior to the electronic message being received by the user, to determine if the electronic message is unwanted, by issuing a challenge in the form of a query to an initiator of the electronic message, receiving a response to the challenge from the initiator, and validating the response to determine its validity, and to pass the electronic message to the user, if the computing device determines that the electronic message is not unwanted.

Thus various embodiments provide a system and method for automatic prevention of unsolicited calls and contacts in voice/video over IP, mobile devices, SMS, peer-2-peer and instant messaging communication technologies, in a simple and efficient manner.

Additionally, some embodiments provide a system and method that prevents computer-based programs from contacting people in order to establish a call and/or contact for sending/playing automated messages (e.g., a marketing message).

Additionally, the some embodiments provide a system and method that does not err by blocking contacts and calls made by humans to humans on a normal requested basis, known as false positive errors.

### BRIEF DESCRIPTION OF THE DRAWINGS

Various embodiments of the present invention will be more fully understood and appreciated from the following detailed description, taken in conjunction with the drawings in which:

FIG. 1A shows a typical environment where two users interact with each other over a voice over IP telephony system, according to the prior art;

FIG. 1B shows a typical environment where two users interact with each other over an instant messaging system, according to the prior art;

FIG. 2A shows a typical environment where an automated machine interacts with a user using a voice over IP telephony system, according to the prior art;

FIG. 2B shows a typical environment where an automated machine interacts with a user over an instant messaging system, according to the prior art;

FIG. 3A illustrates an environment according to an embodiment where a 2^{nd} user and/or an automated machine attempts to contact/call the user, using voice over IP, with an unsolicited contact/call prevention system in place;

FIG. 3B illustrates an environment according to an embodiment where a 2^{nd} user and/or an automated machine attempts to contact/call the user, using instant messaging, with an unsolicited contact/call prevention system in place;

FIG. 4 is a block diagram illustrating how an embodiment of a method operates within an environment like that illustrated in FIGS. 3A and 3B;

FIG. 5 is an example of an unsolicited text message sent by a 2^{nd} user to the end-user using an instant messaging network;

FIG. 6 is an example of a warning message a system may send for call/contact requests that are not available in the allow call/contact list in some embodiments;

FIG. 7 is an example of a challenging message the call/contact initiator needs to reply to in some embodiments; and

FIG. 8 is a system message reporting to the call/contact initiator that his call/contact request was denied in some embodiments.

### DETAILED DESCRIPTION

The present invention, in various embodiments, relates to preventing unsolicited calls and contacts. More particularly, an embodiment relates to a method and system for automatically and continuously preventing unsolicited calls and contacts in voice/video over IP, peer-2-peer, instant messaging, mobile devices, SMS, e-mail and computer networks. In an embodiment, this preventing is carried out in an automatic manner. Alternatively, in other embodiments, semi-automatic and manual methods may be employed.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

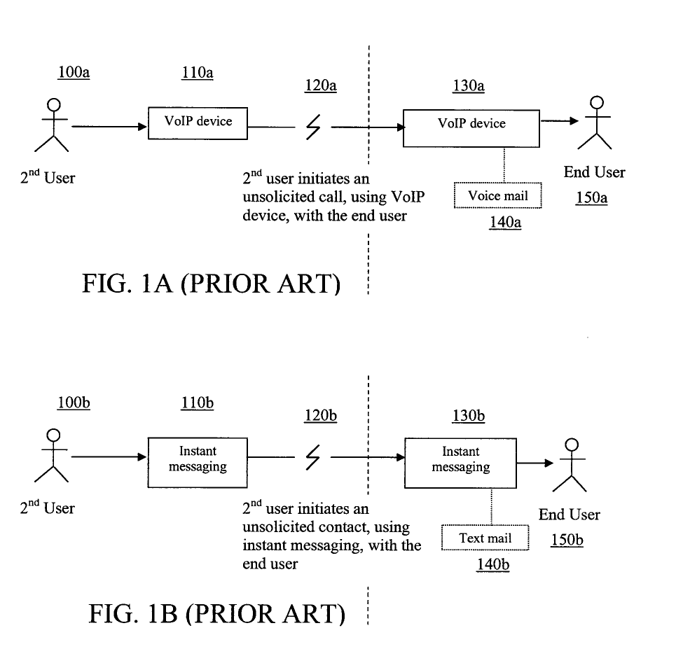

FIG. 1A shows a typical environment where a 2^{nd} user, 100a, uses a voice over IP device, 110a, to initiate a contact/call, 120a, with an end-user, 150a, via a voice over IP device, 130a. In some environments, voice over IP device 130a may have a voice mail service, 140a, available. In the environment described in FIG. 1A, which does not have an automatic prevention system in place, end-user 150a is vulnerable to unsolicited contacts/calls made by the 2^{nd} user 100a.

FIG. 1B shows a typical environment where a 2^{nd} user, 100b, uses an instant messaging device, 110b, to initiate a contact/call, 120b, with an end-user, 150b, via an instant messaging device, 130b. In some environments, instant messaging device 130b may have a text mail service, 140b, available. In the environment described in FIG. 1B, which does not have an automatic prevention system in place, end-user 150b is vulnerable to unsolicited contacts/calls by the 2^{nd} user, 100b.

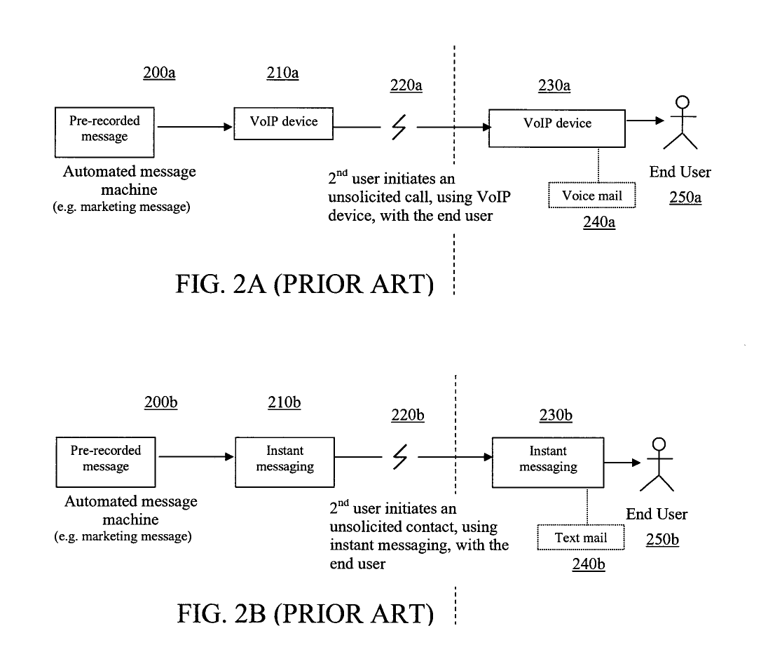

FIG. 2A shows a typical environment where an automated messaging machine, 200a, uses a voice over IP device, 210a, to initiate a contact/call, 220a, with an end-user, 250a, via a voice over IP device, 230a. In some environments voice over IP device 230a may have a voice mail service, 240a, available. In the environment illustrated in FIG. 2A, which does not have an automatic prevention system in place, end-user 250a is vulnerable to unsolicited contacts/calls by automated messaging machine 200a.

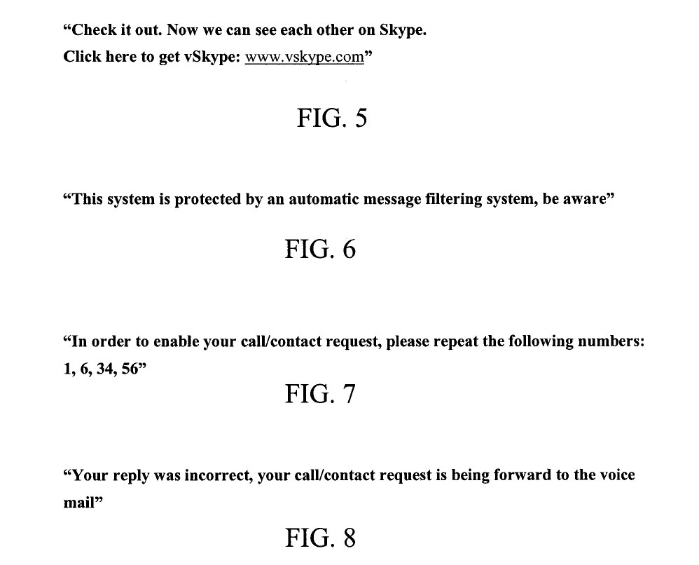

Automated messaging machine 200a is a system and/or computer program, that plays voice and/or text messages that were pre-recorded and/or dynamically and/or semi-dynamically generated. Such a machine includes, inter alia, a tape recorder and a DVD player. For example, as shown in FIG. 5, using automated messaging machine 200a, advertisers and telemarketing services can easily and cost effectively forward marketing messages to many end-users 250a, with minimal effort.

In some embodiments, video over IP is used instead of or in addition to the described voice over IP devices and network. In such case automated messaging machine 200a plays a pre-recorded and/or dynamically and/or semi-dynamically generated video message.

FIG. 2B shows a typical environment where an automated messaging machine, 200b, uses an instant messaging device, 210b, to initiate a contact/call, 220b, with an end-user, 250b, via an instant messaging device, 230b. In some environments instant messaging device 230b may have a text mail service, 240b, available. In the environment described in FIG. 2B, which does not have an automatic prevention mechanism in place, end-user 250b is vulnerable to unsolicited contacts/calls by automated messaging machine 200b. For example, the vulnerable end-user 250b may receive a marketing message forwarded by an automated messaging machine to promote a specific service and/or product.

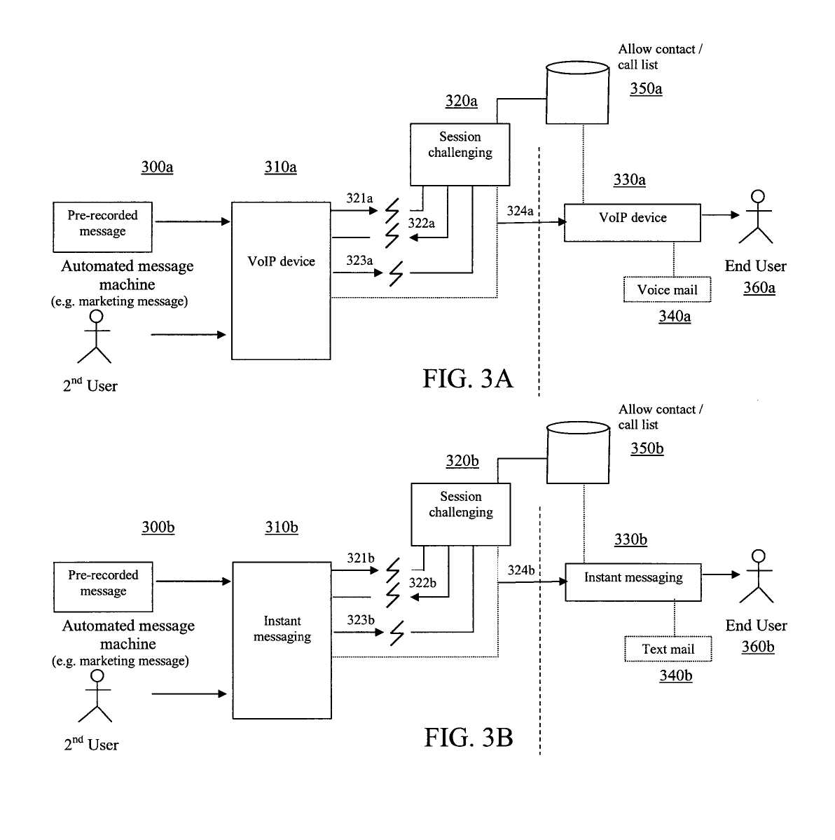

FIG. 3A illustrates the structure of an improved system, according to one embodiment. A 2^{nd} user and/or an automatic message machine, 300a, attempts to initiate a contact/call, 321a, with an end-user, 360a. In one embodiment, a session challenging system, 320a, is installed with the end-user's voice over IP device, 330a, to trap the event of contact/call initialization. On such event 321a, session challenging system 320a retrieves the 2^{nd} user's 300a call/contact attributes, such as, inter alia, call number, identification number, time and location, and checks if one or more attributes are present in an allow contact/call list, 350a. In some embodiments, the process of identifying if one or more attributes are present in allow contact/call list 350a may include additional logical rules.

Having established the presence of the call/contact attribute in list 350a, the session challenging system approves the call/contact initialization 321a, and forwards it to the end-user's voice over IP device 330a.

If the call/contact attributes are not found in list 350a, session challenging system 320a replies to initiator 300a via voice over IP device 310a, with a challenging message, 322a, such as the message illustrated in FIG. 7. In some embodiments, session challenging system 320a may reply with a pre-recorded and/or automatically and/or semi-automatically generated message to initiator 300a, via voice over IP device 310a. In other embodiments, if the call/contact attributes are not found in list 350a then session challenging system 320a forwards the call/contact to a voice mail system 340a, without interrupting end-user 360a.

Challenging message 322a may be, inter alia, a voice message asking initiator 300a to dial and/or repeat a sequence of one or more digits and/or letters. In addition or alternatively, challenging message 322a may be, inter alia, a voice message asking initiator 300a one or more questions to be answered either verbally or by dialing one or more numbers and/or letters.

If a reply is not received from initiator 300a within a pre-defined time limit, session challenging system 320a drops the call/contact request 321a.

If a reply, 323a, from initiator 300a to challenge message 323a is received within the pre-defined time limit, session challenging system 320a checks if reply 323a is correct. In some embodiments, the validation process may include additional logical rules. If reply 323a is determined to be correct, session challenging system 320a then forwards the call to end-user 360a via voice over IP device, 330a. In some embodiments, session challenging system 320a also updates allow contact/call list 350a with the validated call attributes.

If reply 323a is determined to be incorrect, session challenging system 320a drops the call/contact request, and may issue a notification to 2^{nd} user 300a, such as the notification illustrated in FIG. 8. In some embodiments, session challenging system 320a forwards the call/contact request to voice mail system 340a, without interrupting end-user 360a.

Session challenging system 320a may be coupled with voice over IP device, 330a, or alternatively it may reside at a location that can trap the event of initiating a call/contact with end-user 360a.

Allow contact/call list 350a may be coupled with voice over IP device 330a, or alternatively it may reside at a location that session challenging system 320a can query.

Voice mail system 340a may be coupled with voice over IP device 330a, or alternatively it may reside at a location that session challenging system 320a can forward call/contact requests to.

FIG. 3B illustrates the structure of an improved system, according to one embodiment. A 2^{nd} user and/or an automatic message machine, 300b, attempts to initiate a contact/call, 321b, with an end-user, 360b. In one embodiment, a session challenging system, 320b, is coupled with the end-user's instant messaging device, 330b, to trap the event of contact/call initialization. On such event, 321b, session challenging system 320b, retrieves the 2^{nd} user's 300b call/contact attributes, such as, inter alia, call number, identification number, time and location, and checks if one or more attributes are already present in an allow contact/call list, 350b. In some embodiments, the process of identifying if one or more attributes are present in allow contact/call list 350b may include additional logical rules.

If the call/contact attribute is present in list 350b, session challenging system 320b approves the call/contact initialization, 321b, and forwards it to the end-user's instant messaging device 330b.

If the call/contact attribute is not present in list 350b, session challenging system 320b replies to initiator 300b, via instant messaging device 310b, with a challenging message, 322b, such as the message illustrated in FIG. 7. In some embodiments, session challenging system 320b may reply with a pre-recorded and/or automatically and/or semi-automatically generated message to initiator 300b, via instant messaging device 310b. In other embodiments, if the call/contact attributes are not found in list 350b, session challenging system 320b forwards the call/contact to a text mail system, 340b, without interrupting end-user 360b.

Challenging message 322b may be, inter alia, a text message asking initiator 300b to type and/or repeat a sequence of one or more digits and/or letters, such as the text message illustrated in FIG. 7. Additionally or alternatively, challenging message 322b may be, inter alia, a text message asking initiator 300b one or more questions to be answered by typing one or more numbers and/or letters.

If a reply is not received from initiator 300b within a pre-defined time limit, session challenging system 320b drops the call/contact request 321b.

If a reply, 323b, from initiator 300b to challenging message 323b is received within the pre-defined time limit, session challenging system 320b checks if reply 323b is correct. In some embodiments of the present invention, the validation process may include additional logical rules. If reply 323b is determined to be correct, session challenging system 320b forwards the call to end-user 360b, via instant messaging device 330b. In some embodiments of the present invention, session challenging system 320b also updates the allow contact/call list 350b with the validated call attributes.

If reply 323b is determined to be incorrect, session challenging system 320b drops the call/contact request. In some embodiments of the present invention, session challenging system 320b forwards the call/contact request to text mail system 340b, without interrupting end-user 360b.

Session challenging system 320b may be coupled with instant messaging device 330b, or alternatively it made reside at a location that can trap the event of initiating a call/contact with end-user 360b.

Allow contact/call list 350b, may be coupled with instant messaging device 330b, or alternatively it may reside at a location that session challenging system 320b can query.

Text mail system 340b may be coupled with instant messaging device 330b, or alternatively it may reside at a location that session challenging system 320b can forward call/contact requests to.

The systems of various embodiments illustrated in FIGS. 3A and 3B, may be implemented in software, in hardware or in a software/hardware combination.

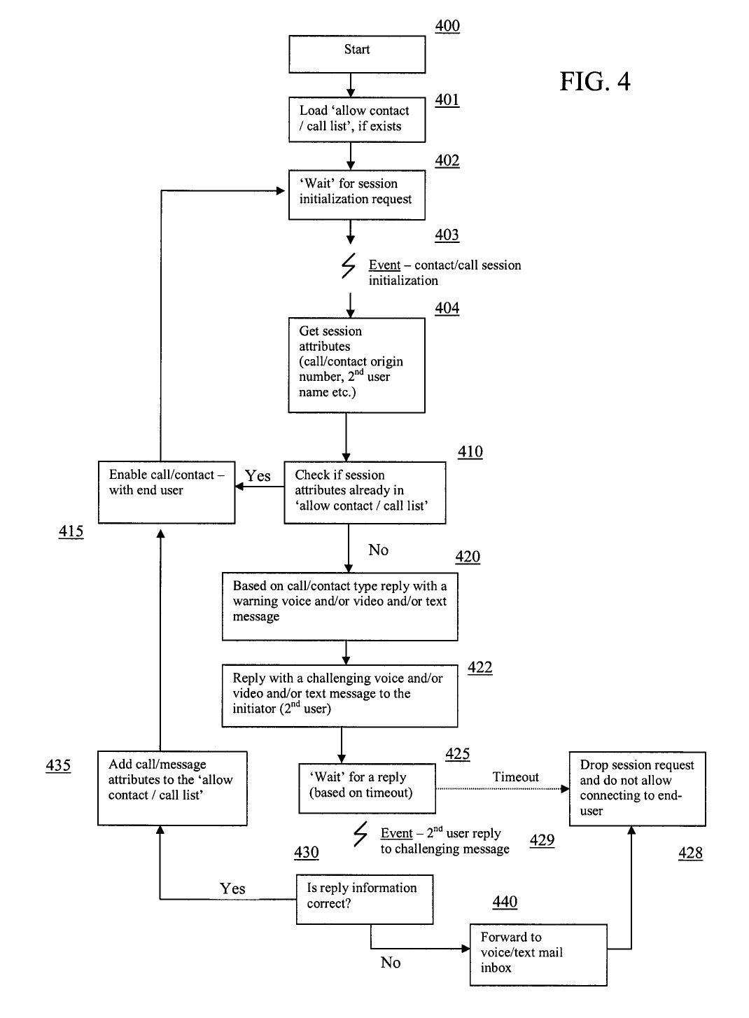

FIG. 4 is a block diagram illustrating operation of an improved method according to one embodiment. After starting at step 400, the method loads an allow contact/call list, 401. Allow contact/call list 401 includes call/contact attributes which, if matched with an incoming call/contact request, are allowed to initiate a call/contact with the end-user. After loading the list, the method waits for a call/contact session initialization request, 402, to occur. On event, 403, the method retrieves session attributes by querying the initiating party, 404. In some embodiments, the attributes can be, inter alia, caller ID, caller name, location and number. Having the attributes, the method checks if one or more of these attributes are already present in the allow contact/call list, 410. In some embodiments, the checking process may include additional logical rules. If the call/contact attributes are present in the list, the method enables the call/contact initialization, 415, and forwards it to the end user. The method continues to wait for additional session initialization requests, 402.

If the method does not find the attributes in the allow contact/call list, in some embodiments, it replies to the initiating party with a warning message that was pre-recorded, automatically and/or semi-automatically generated, 420, such as the warning message illustrated in FIG. 6. In some embodiments, the warning message is in text and/or video format. If the software does not find the attributes in the allow contact/call list, it also replies with a challenging message to the initiator party, 422, such as the challenging message illustrated in FIG. 7. The challenging message may be, inter alia, a text message asking the initiator to type and/or repeat a sequence of one or more digits and/or letters. In addition or alternatively, the challenging message may be, inter alia, a text message asking the initiator one or more questions to be answered by typing one or more numbers and/or letters; and/or a voice/video message asking the initiator one or more questions to be answered by typing numbers and/or letters.

Following the challenging message, the method waits for a reply from the initiator, 425. In some embodiments, the method waits for a pre-defined time limit and, if a reply is not received within the time limit, the method drops the session request and does not allow connection to the end-user, 428. On event, 429, the method validates the reply for correctness, 430. In some embodiments, the validation process may include additional logical rules. If the reply is determined to be correct, the method forwards the call to the end-user, 415. In some embodiments, the method also updates the allow contact/call list, 435, with the validated call attributes.

If the reply is determined to be incorrect, the method drops the call/contact request, 428, and may issue a notification to the initiating party, such as the notification illustrated in FIG. 8. In some embodiments, the software forwards the call/contact request to the text/voice/video mail system, 440, without interrupting the end-user.

The method of the embodiment illustrated in FIG. 4 may be implemented in software, in hardware or in a software/hardware combination.

FIG. 5 is an example of an unsolicited marketing message that was received over an instant messaging system, which various embodiments can block.

One skilled in the art will appreciate that although specific examples and embodiments of the system and methods have been described for purposes of illustration, various modifications can be made without deviating from the present invention. For example, embodiments of the present invention may be applied to many different types of databases, systems and application programs. Moreover, features of one embodiment may be incorporated into other embodiments, even where those features are not described together in a single embodiment within the present document.

What is claimed is:

1. A system for preventing unwanted calls, comprising:
a transmitter, for transmitting an electronic message to a user;
a receiver communicatively coupled with said transmitter, for receiving the electronic message intended for the user; and
a message filter coupled with said receiver, including:
a message interceptor, for intercepting the electronic message, transmitted by said transmitter, prior to the electronic message being received by said receiver;
a verification processor, for determining if the electronic message is unwanted, including:
a challenge originator, for issuing a challenge in the form of a query to said transmitter; and
a validator, for receiving a response to the challenge from said transmitter and for determining the validity of the response; and
a message manager, for passing the electronic message to said receiver, if said verification processor determines that the electronic message is not unwanted.

2. The system of claim 1 further comprising a storage of allowable contacts, the storage including a plurality of contact information, wherein the electronic message has specific contact information associated therewith, and wherein said message filter passes the electronic message to said receiver if the specific contact information is present in the storage of allowable contacts.

3. The system of claim 2 wherein said message manager issues a warning notification to said transmitter, if the specific contact information is not present in the storage of allowable contacts.

4. The system of claim 2 further comprising a storage manager, for adding the specific contact information to the storage of allowable contacts if said validator determines that the response received from said transmitter is valid.

5. The system of claim 4 wherein the storage manager enables the user to add, delete and edit contact information within the storage of allowable contacts.

6. The system of claim 1 wherein said verification processor determines that the electronic message is unwanted, if said validator does not receive a response to the challenge within a pre-determined time limit.

7. The system of claim 1 wherein said message manager logs the electronic message, if said verification processor determines that the electronic message is unwanted.

8. The system of claim 1 wherein said message manager sends a denial notification to said transmitter, if said verification processor determines that the electronic message is unwanted.

9. The system of claim 1 wherein said challenge originator randomly generates the challenge.

10. The system of claim 1 wherein said challenge originator generates the challenge from a pre-determined list of queries.

11. The system of claim 1 wherein said challenge originator generates an oral challenge.

12. The system of claim 1 wherein said challenge originator generates a text challenge.

13. The system of claim 1 wherein said challenge originator generates a video challenge.

14. The system of claim 1 wherein said validator receives a tonal response, the system further comprising an analog to digital converter, for converting the tonal response into a digital response.

15. The system of claim 1 wherein said validator receives an oral response, the system further comprising an analog to digital converter, for converting the oral response into a digital response.

16. A method for preventing unwanted calls, comprising:
intercepting an electronic message intended for delivery to a user, prior to the electronic message being received by the user;
determining if the electronic message is unwanted, including:
issuing a challenge in the form of a query to an initiator of the electronic message;
receiving a response to the challenge from the initiator; and
validating the response to determine its validity; and
passing the electronic message to the user, if said determining determines that the electronic message is not unwanted.

17. The method of claim 16 wherein the electronic message has specific contact information associated therewith, the method further comprising searching a plurality of allowable contact information for the presence of the specific contact information, and wherein said passing passes the electronic message to the user if the specific contact information is present in the plurality of allowable contact information.

18. The method of claim 17 further comprising issuing a warning notification to the initiator, if the specific contact information is not present in the plurality of allowable contact information.

19. The method of claim 18 further comprising adding the specific contact information to the plurality of allowable contact information, if said validating determines that the response received from the initiator is valid.

20. The method of claim 19 further comprising adding, deleting and editing contact information, by the user, within the plurality of allowable contact information.

21. The method of claim 16 wherein said determining determines that the electronic message is unwanted, if a response to the challenge is not received within a pre-determined time limit.

22. The method of claim 16 further comprising logging the electronic message, if said determining determines that the electronic message is unwanted.

23. The method of claim 16 further comprising sending a denial notification to the initiator, if said determining determines that the electronic message is unwanted.

24. The method of claim 16 wherein said issuing randomly generates the challenge.

25. The method of claim 16 wherein said issuing generates the challenge from a pre-determined list of queries.

26. The method of claim 16 wherein said issuing generates an oral challenge.

27. The method of claim 16 wherein said issuing generates a text challenge.

28. The method of claim 16 wherein said issuing generates a video challenge.

29. The method of claim 16 wherein said receiving receives a tonal response, the method further comprising converting the tonal response into a digital response.

30. The method of claim 16 wherein said receiving receives an oral response, the method further comprising converting the oral response into a digital response.

31. The method of claim 16 further comprising storing a result of said validating in a database.

32. A computer-readable storage medium storing program code for causing at least one computing device:
to intercept an electronic message intended for delivery to a user, prior to the electronic message being received by the user;
to determine if the electronic message is unwanted, by:
issuing a challenge in the form of a query to an initiator of the electronic message;
receiving a response to the challenge from the initiator; and
validating the response to determine its validity; and
to pass the electronic message to the user, if the computing device determines that the electronic message is not unwanted.
